(19) United States
(12) Patent Application Publication
(10) Pub. No.: US 2002/0005259 A1
(43) Pub. Date: Jan. 17, 2002

(54) Labeling machine

(76) Inventors: Martin Malthouse, Toronto (CA); Dean Dingjian Huang, Edison, NJ (US)

Correspondence Address: Ralph A. Dowell, DOWELL & DOWELL PC, STE 309, 1215 JEFF DAVIS HWY, ARLINGTON, VA, 22202, US

(21) Appl. No.: 09/849,368

(22) Filed: May 7, 2001

Related U.S. Application Data
(63) Continuation of application No. PCT/CA99/01046, filed on Nov. 5, 1999.

(30) Foreign Application Priority Data
Nov. 5, 1998 (CA) 2,253,018

(51) Int. Cl. B32B 31/00

(52) U.S. Cl. 156/516

(57) ABSTRACT

A labeling machine includes a knife station for severing labels from a roll. The knife station can be swung on a pivot to allow access to the stationary and rotating knife. Adjustment is made at the stationery knife by varying the separation of a pair of bifurcated arms. Labels are held on the labeling head by a vacuum system that varies the vacuum as the head rotates past the glue station. The glue station has a glue roller supported against lateral forces at its lower edge on a bearing. Its upper edge is supported on an axially floating bearing.

This application is a Continuation of PCT Application No. PCT/CA99/01046 filed on Nov. 5, 1999

### BACKGROUND OF THE INVENTION

1. FIELD OF THE INVENTION

The present invention relates to labeling machines.

2. DESCRIPTION OF THE PRIOR ART

Labeling machines are used to apply a label to a container for identification and/or aesthetic reasons. Conventionally, labels have been supplied from pre-cut stacks of printed labels which are fed individually to a labeling head for application to a container. More recently, labels have been supplied as rolls of printed stock so that labels can be severed from the roll as they are applied to the container.

Roll fed labeling is recognized to be more economical but the complexity of the labeling machine is increased due to the need to control the feed and cutting of the label stock.

The complexity of the labeling procedure has also increased as new labeling materials are developed. Besides the conventional paper stock, labels are now made from films and laminates, some of which are heat shrinkable, which each present particular problems in handling. Moreover some labeling machines are used with a dedicated container; most have to be capable of conversion from one container to another as demand for product varies. A change of container will invariably require a change in label with variations in size, feed rate and possibly material.

Despite the flexibility of labeling machines, of paramount importance in the operation of the machine is the quality of the finished-labeled product as increasingly the label is used for aesthetic purposes. Not only must the labeling machine be capable of handling different applications, it must do so in a consistent reliable manner and at high speed.

A labeling machine will typically have a label feed station, a labeling head to carry the label from the feed station to a glue applicator to apply the adhesive to the label and, subsequently, to the container to which the label is affixed. A particularly successful labeling machine is disclosed in U.S. Pat. No. 4,323,416 to Malthouse et al which is herein incorporated by reference. In this patent, a labeling device is taught having a belt entrained about a labeling head and used to effect the transfer of the label from the head to the container. The belt is moving faster than the labeling head and therefore draws the label under tension on to the container. The belt also serves to roll the container away from the head to maintain control of the label at all times. This machine has proven successful in handling a variety of different labels and containers and providing the requisite quality in view of the close control maintained for the label stock.

Other United States patent related to the above mentioned '416 reference and describing similar devices are as follows: U.S. Pat. Nos. 4,561,928; 4,526,645; 4,448,629; and, 4,447,280, the disclosures of which are herein incorporated by reference.

The application of electronic controls to the drives of the labeling machines has enabled them to be used in a wider variety of applications. This has highlighted the need for efficient changeover of equipment between applications and the need to be able to perform adjustments in an effective and efficient manner. The introduction of new label materials increases the need to provide precise control of the label during application.

It is therefore an object of the present invention to provide a labeling machine in which versatility is enhanced while control of the label is maintained.

### SUMMARY OF THE INVENTION

Therefore, in one embodiment, the present invention provides a labeling machine having a roll of labels, a knife station to sever the labels from the roll, and a label carrier to carry the labels from the knife station to a container, the knife station including a stationary knife assembly and a rotating knife assembly mounted in a housing, the housing being rotatable relative to the carrier to provide access to the knife assemblies.

In another embodiment, the invention provides a labeling machine having a knife station to sever labels from the roll and a label carrier to carry labels from the knife station to a container, the knife station including a stationary knife assembly and a rotating knife assembly, the stationary knife assembly including an anvil and a support, the support having a pair of legs and an adjusting element acting between the legs to vary the spacing therebetween and thereby the position of the anvil relative to the rotating knife assembly.

In yet another embodiment, the invention provides a labeling machine having a label carrier to carry labels from a supply of labels to a container, the carrier including a plurality of label stations to receive the labels as they are fed to the carrier, each station having connections to a vacuum to retain the labels on the carrier, the vacuum being modulated as the carrier moves toward the container to vary the retention of labels on the label station.

In a further embodiment, a glue applicator for a labeling machine, the glue applicator including a roller rotatably mounted on a frame, the roller having upper and lower ends with a bearing located at the lower end to resist lateral loads and a bearing located at the upper end axially displaceable to accommodate relative axial movement between the frame and roller.

### BRIEF DESCRIPTION OF THE DRAWINGS

These and other features of the preferred embodiments of the invention will become more apparent in the following detailed description in which reference is made to the appended drawings wherein:

FIG. 1 is a plan view of a labeling machine.

FIG. 2 is a section on the line II-II of FIG. 1.

FIG. 3 is a section on the line III-III of FIG. 2.

FIG. 4 is a section on the line IV-IV of FIG. 1.

FIG. 5 is a plan view of FIG. 4.

FIG. 6 is a view on the line VI-VI of FIG. 4.

FIG. 7 is a view on the line VII-VII of FIG. 6.

FIG. 8 is a section on the line VIII-VIII of FIG. 7.

FIG. 9 is a section on the line IX-IX of FIG. 7.

FIG. 10 is a section on the line X-X of FIG. 7.

FIG. 11 is a section on the line XI-XI of FIG. 1.

### DESCRIPTION OF THE PREFERRED EMBODIMENTS

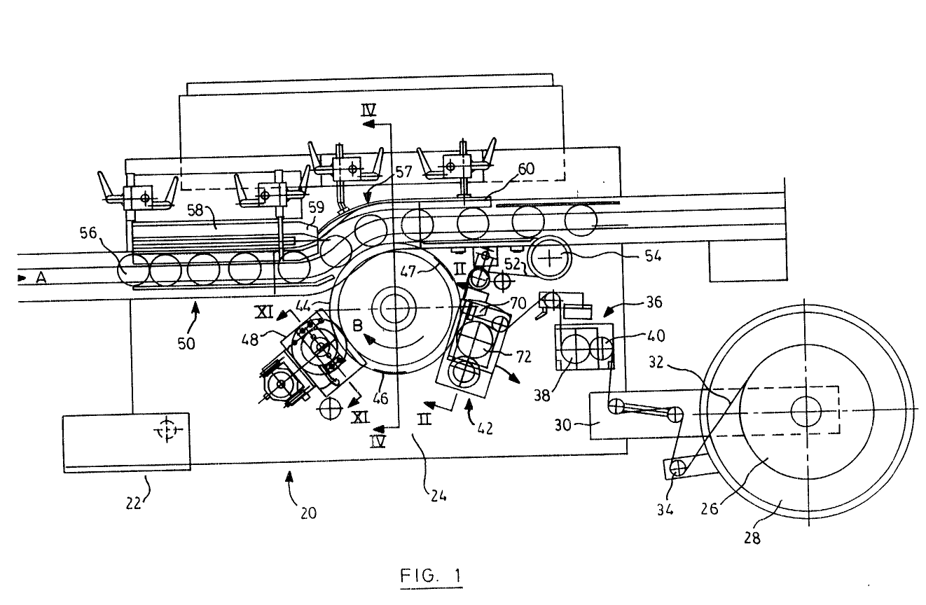

Referring therefore to FIG. 1, a labeling machine 20 includes a frame 22 with a base plate 24. A label roll 26 is camed on a roll holder 28 that is cantilevered on an arm 30 from the frame 22.

The roll holder 28 is rotatable relative to the arm 30 and allows label stock 32 to be drawn over idle rollers 34 under the control of a draw roll assembly 36. The draw roll assembly 36 has a draw roll 38 driven by a microprocessor controlled servo motor (not shown) and a pinch roll 40 to maintain the label stock 32 against the draw roll 38. The draw roll assembly 36 is conventional and well known in the art and therefore will not be described in further detail.

Label stock 32 passes from the draw roller assembly 36 to a knife station 42. The knife station 42, which will be described in further detail below, is located adjacent a labeling head 44 and severs individual labels 46 from the stock 32.

Labeling head 44 is rotatably mounted on the base plate 24 and carries the labels 46 on individual label stations 47 past a glue station 48 toward a conveyor 50. A belt 52 is entrained about the labeling head 44 below the peripheral surface of the head and extends partially along the conveyor 50 and around drive roller 54. Drive roller 54 drives the belt 52 at a greater linear speed than the periphery of the labeling head 44 and so is slipping relative to the head 44.

Conveyor 50, moving in a direction shown at A, delivers containers 56 to the labeling head 44 through a timing device, such as a rotating helical worm 58, and guides the containers around a segment of the labeling head 44 as the labels 46 are applied. In the embodiment shown, the labeling head 44 rotates in a direction indicated at B. The worm 58 is mounted on a suitable support. A backing plate 60 supports the containers 56 as they pass around the labeling head 44 and along the conveyor 50 causing the containers 56 to roll along the plate 60. The rolling motion draws the label 56 of the head 44 and wraps it onto the container 56 under the control of belt 52. This action is described more fully in the references discussed above.

As illustrated in FIG. 1, the conveyor 50 preferably includes a sigmoidal curve 57 so as to allow the conveyor to partially wrap around the labeling head 44. Such a curve is preferably used where a longer contact time is required between the labeling head 44 and the container 56. This situation arises in the case of large diameter containers or where large labels are used. This is due to the fact that, in the usual case, the adhesive for the label is applied only to the ends thereof. Therefore, the labeling head 44 and the container must contact over the entire length of the label so that the ends of the label are properly affixed to the surface of the container. In another embodiment, for small containers or small labels, the conveyor 50 may be straight since the increased contact time between the labeling head and container is not needed.

The worm 58 serves to restrict the passage of the containers 56 travelling towards the labeling head 44. As seen in FIG. 1, the containers 56 accumulate on the conveyor 50, upstream of the labeling head 44. The rotating worm 58 then allows each container to pass through at set timing intervals. In the preferred embodiment, one revolution of the labeling head 44 is timed with three revolutions of the worm. It will be understood by persons skilled in the art that any other known devices can be used to provide the required timing function of the worm. Other such devices may include, for example, flighted chains or star wheels.

In the preferred embodiment, where a worm is used as the timing device, a nose cone 59 is provided at the downstream end of the worm 58. The nose cone 59 comprises a helical worm having a tapered root as compared to the worm 58. FIG. 12 illustrates a nose cone 59 attached to the terminal end of the worm 58. As shown, the curvature of the nose cone corresponds to the curvature of the labeling head 44. The nose cone 59 permits the containers 56 to travel along the curved portion 57 of the conveyor so as to meet the timing requirements described above and to maintain contact between the container 56 and the labeling head 44. It will be appreciated that for conveyors not having a curve 57, that is, conveyors with a straight path, a worm with a nose cone as described would not be required.

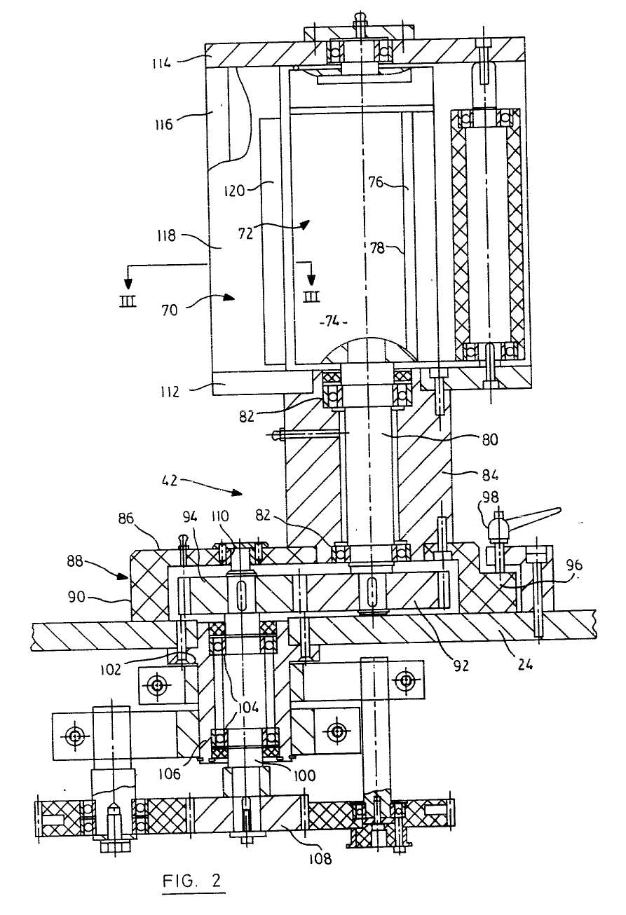

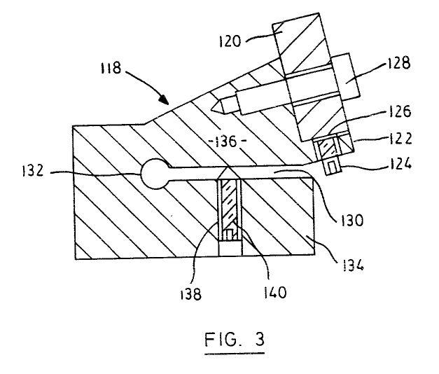

Knife station 42 includes a stationary blade assembly 70 and a rotating knife 72 as may be seen in greater detail in FIGS. 2 and 3. Rotating knife 72 includes a barrel 74 with a knife blade 76 located in a groove 78 and extending generally along the longitudinal axis of the barrel 74. The blade 76 is preferably hardened and is positioned so as to extend radially outward from the barrel 74. As will be described below, the rotating knife 72 cooperates with a stationary blade assembly 70 to achieve a scissors-like action. The barrel 74 is mounted on a shaft 80 that is supported on bearings 82 within a tubular extension 84. The extension 84 is secured to the top plate 86 of a drive housing 88 which includes sidewalls 90 that extend down to the base plate 24.

The gear 92 is connected to the shaft 80 to transmit drive to the barrel 74 from the gear 94. The gear 94 is mounted on a shaft 100 that is secured in a trunnion block 102 mounted on the base plate 24. Trunnion block 102 includes a pair of roller bearings 104 located in a cylindrical sleeve 106 that axially locates the shaft 100 relative to the base plate 24. The lower end of the shaft 100 is connected to a drive gear 108 that receives rotational drive from the motor (not shown). Upped end of shaft 100 extends beyond the gear 94 to a pilot hearing 110 located in the top plate 86. The bearing 110 thus locates the drive housing 88 relative to base plate 24 but permits it to swing about the axis of the shaft 100 upon release of the clamping screw 98.

Stationery blade assembly 70 is supported for movement with the housing 88 between a bottom plate 112 and top plate 114 located at opposite ends of the barrel 74. The bottom plate 112 is secured to the extension 84 and is rigidly connected to the top plate 114 by vertical frame members 116. The stationary knife assembly includes an elongate support block 118 and a stationary knife or anvil 120 secured to the block 118 and positioned to a cooperate with the blade 76 to perform a cutting action. Adjustment of the anvil 120 relative to blade 76 is critical for effective cutting and accordingly provision is made in the stationary knife assembly for such adjustment.

As can best be seen in FIG. 3, anvil 120 is located on a ledge 122 formed along one edge of support block 118. The ledge 122 is tapped at locations along its length to receive socket screws 124. The screws 124 bear against a side face 126 of the anvil 120 and position the anvil 120 relative to the path of the knife blade 76 shown in chain dot line. Cap bolts 128 secure the anvil 120 to the support block 118 once positioned by the screws 124.

To permit fine adjustment without releasing the bolts 128, the support block 118 is formed with an elongate groove 130 terminating at a cylindrical bore 132. The groove 130 subdivides the block 118 into a pair of legs 134, 136 and tapped holes 138 are provided at longitudinally spaced intervals in one of the legs 134. Adjusting screws 140 are threaded into the holes 138 and bear against the other leg 136. The legs 134, 136 can therefore be flexed apart to adjust the position of the anvil 120. As mentioned above, the support block 118 is attached between plates 112 and 114. However, in order for adjustment of the stationary knife 120 to freely occur, the block 118 is attached to the plates through the leg 134 thereby rendering leg 136 to be free to move with respect thereto.

Because the knife station 42 is mounted as a unit on the drive housing 88, it may be swung away from the labeling head 44, as indicated by the arrow in FIG. 1, to permit access to the knife adjustments. The position of the anvil 120 may then be adjusted using the screws 124 and 140 and the knife station then swung back to the operative position. Access to and adjustment of the knife station is thus facilitated.

Moreover, the housing 88 and knife station 42 may be removed as a unit from the base plate by simply lifting the housing 88 from the shaft 100 to give access to the drive gears 92, 94. When the relationship of web speed and rotary knife body diameter become incompatible, the entire knife station 42 may be changed by disengaging gears 92 and 94. In such case, clamping screw 98 is loosened and knife station 42 is lifted and rotated about the bearing 110. This therefore allows easy access to the stationary blade assembly 70 while the gear 92 is left remaining in place. In this manner, the blade assembly can be exposed for replacing the knife blades or for making any needed adjustments to position of the blade 120 by means of the adjustment screws 140.

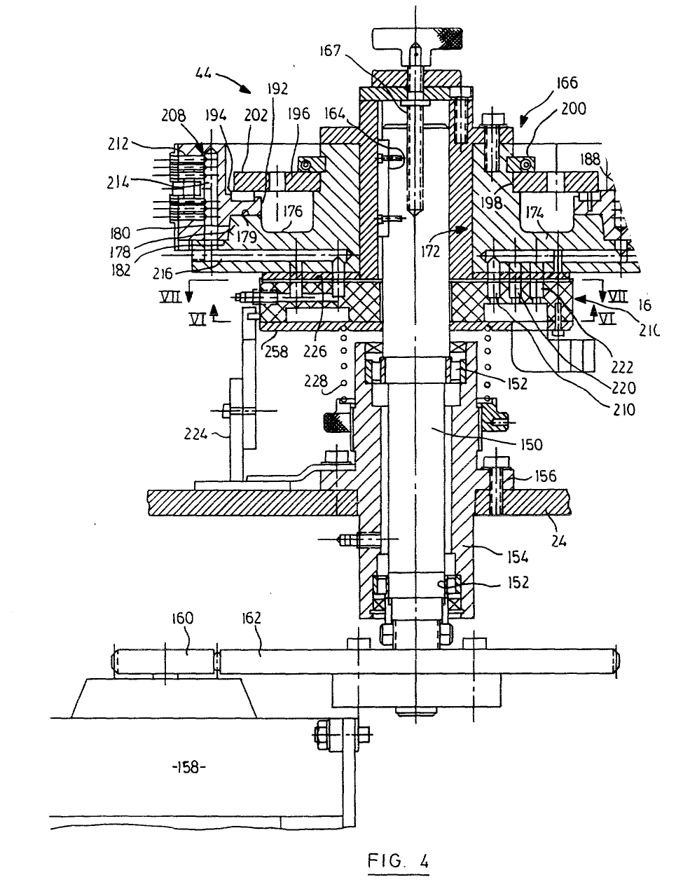

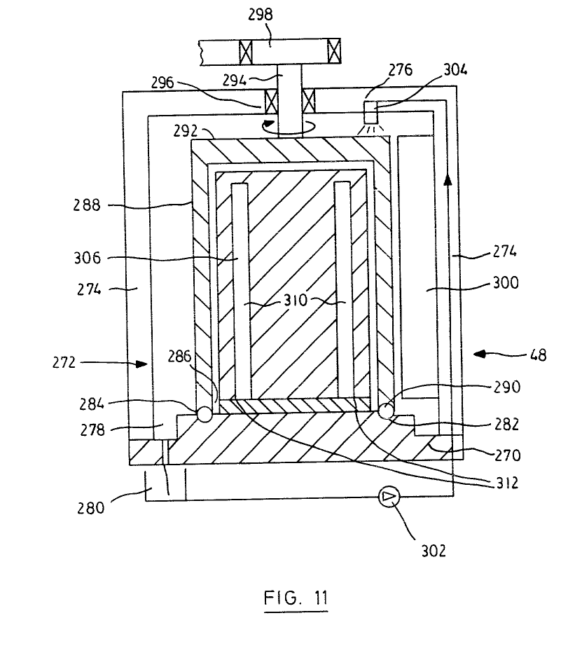

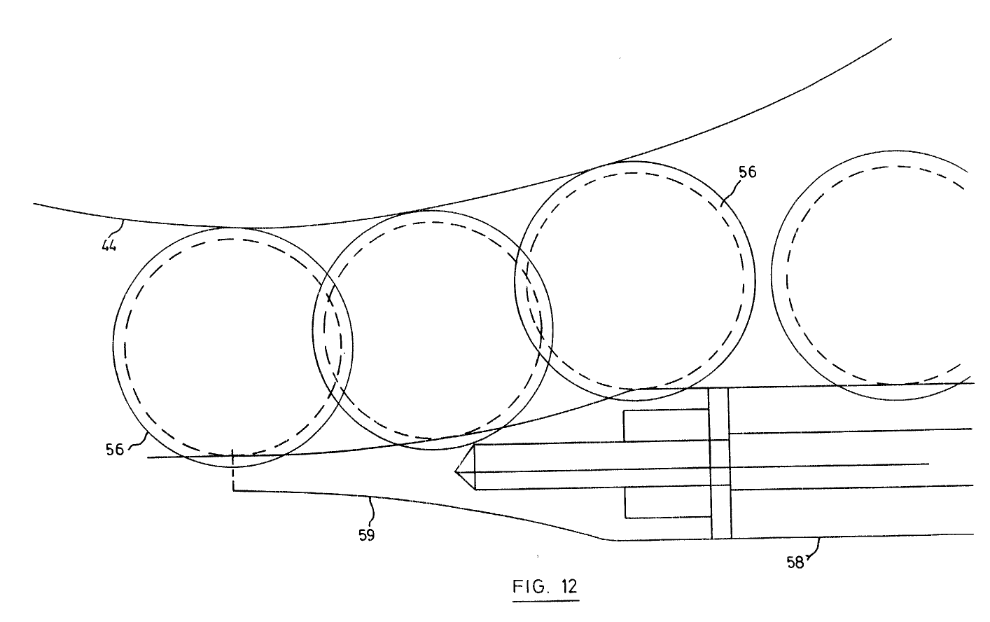

Labeling head 44 is also designed to facilitate change to different configurations and control of the label as can best be seen in FIGS. 4 to 9. Referring initially to FIG. 4, labeling head 44 includes a drive shaft 150 that is supported by tapered roller bearings 152 in a tubular housing 154. The housing 154 is secured by a flange 156 to the base plate 24 and the drive shaft 150 extends below the base plate to receive a drive motor 158 through bull gears 160, 162. It will be understood that motor 158 also drives the knife station 42 and glue station 48 through respective gear trains.

Shaft 150 is connected by a key 164 to a labeling head 166 which is located axially by a threaded pin 167 acting between the shaft and carrier. The labeling head 166 includes a base 168 and a label carrier 170. The base 168 has a hub 172 and a radial flange 174 extending outwardly from the hub 172. Upper surface 176 of the flange 174 is formed with an upstanding annular ring 178 having a planar top surface 179 and a frusto conical radially outer surface 180. The surface 180 terminates in a radially extending planar flange 182.

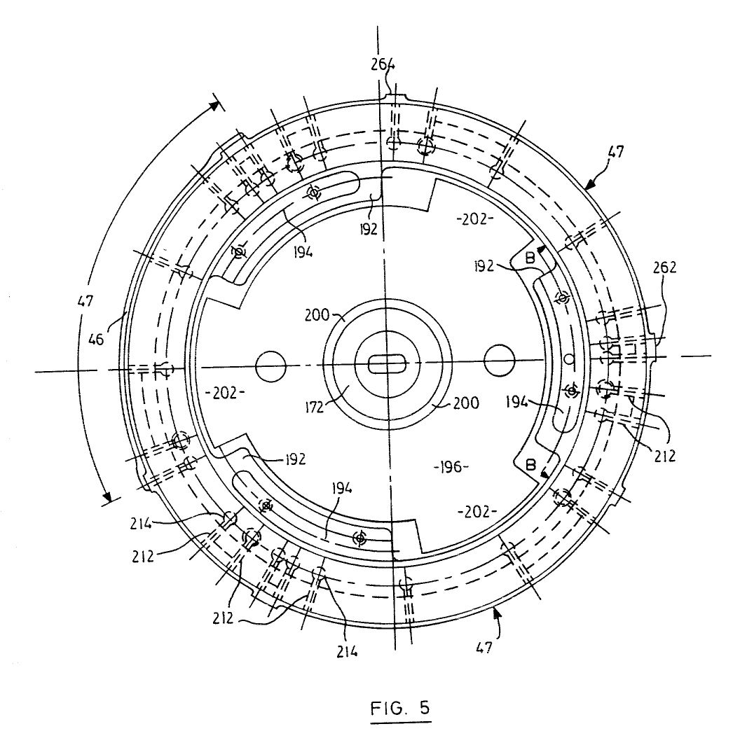

The label carrier 170 is annular with a peripheral surface 184 that is segmented into a series of label stations 47 indicated on FIG. 5. A peripheral groove 186 is provided in the surface 184 to accommodate the belt 52. A slip ring 188 is located in the groove 186 between the belt and the carrier to allow the belt 52 to move faster than the carrier 170.

The radially inner face of the carrier 170 is formed with lower surfaces 190 that are complementary to the surfaces 179, 180, 182 on ring 178 so as to form a seal with them. A segmented flange 192, best seen in FIG. 5, extends over the planar surface 170 and carries wedge shaped wear pads 194 on the upper surface of each segment. The wear pads 194 progressively increase in axial thickness in the circumferential direction and therefore provide a ramped upper surface to the segmented flange 192.

The carrier 170 is secured to the hub 168 by a locking ring 196. The locking ring 196 is located in a rabbet 198 formed on the hub 172 and is axially located by a pair of c-rings 200 so that it is free to rotate. The radially outer portion of the locking ring 196 has three fingers 202 which radially overlap the segmented flange 192. The circumferential extent of the fingers 202 is less than the spacing between segments of the flange 192 so that the locking ring may be positioned as shown in FIG. 5 to allow axial movement of the carrier 170. With the carrier positioned on the hub 172, the locking ring 196 is rotated about the hub 172 to bring the fingers 202 in engagement with the wear pads 194. As the locking ring 196 is rotated, the fingers 202 ride along the pads 194 to force the complementary surfaces of the carrier 170 and hub 168 into engagement. The carrier 170 may be removed by simply rotating the locking ring 196 off the cam surfaces and lifting the carrier off the hub. This facilitates the changing of the labeling head to different configurations with a minimum of disassembly.

As may be noted from FIGS. 4 and 5, each of the label stations is connected by internal ducts 208 to a valve plate 210. The internal ducts 208 include a series of radial branches 212 that intersect the face of the label station 47 and extend to an axial gallery 214. The axial gallery 214 communicates with a radial gallery 216 in the flange 174 which in turn communicates with up to three feeder galleries 218, 220, 222 radically spaced on one of three pitch circles. As will be explained below, the exact configuration of the feeder galleries will depend upon the location of the branch ducts on the label station 47, it being understood that internal ducts are provided for each of the branch ducts indicated in FIG. 5.

The application of vacuum to the internal ducts is controlled by valve plate 210 which is maintained stationary relative to the base plate 24 by strap 224. A seal plate 226 is positioned between the value plate 210 and hub 168 and a spring 228 biases the plates 210 against the hub 172.

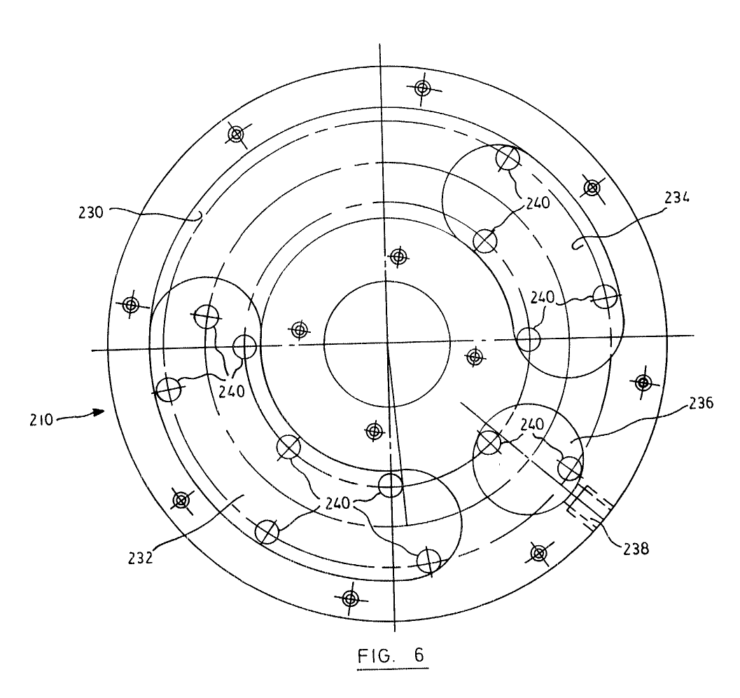

The details of the plate 210 can best be seen in FIGS. 6 to 9. Referring firstly to FIG. 6, the underside of plate 210 is formed with a kidney shaped gallery 230 with a deeper recess 232, 234 at opposite ends. A circular gallery 236 is positioned between the ends of the kidney shaped gallery 230 and communicates with a radial port 238.

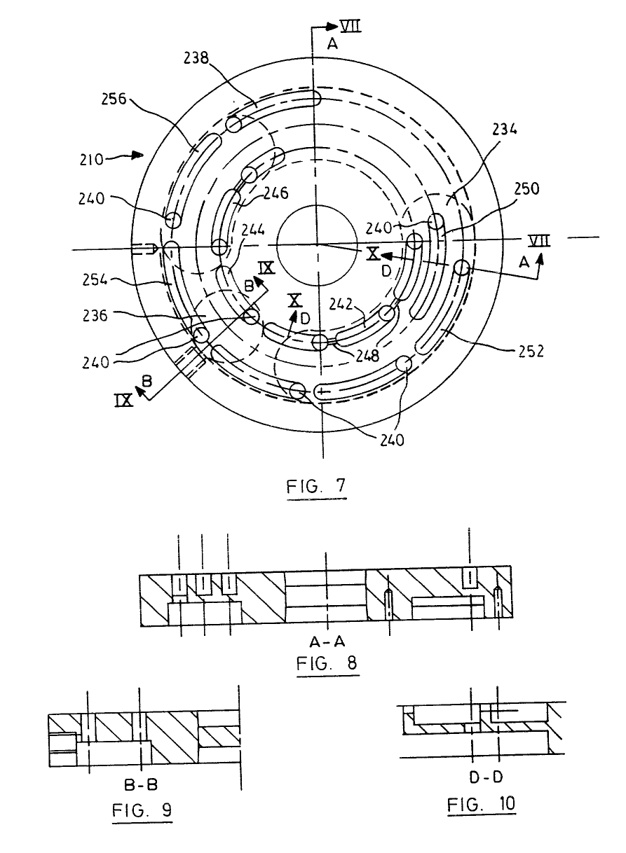

Through holes 240 extend from the recesses 232,234 to the opposite top face of the valve plate 210. The holes 240 are located on one of three pitch circles, indicated in chain dot lines and corresponding to the pitch circles of the feeder galleries 218, 220, 222. The through holes communicate with selected circumferential grooves shown most clearly in FIG. 7.

At the radially inner pitch circle, three circumferential grooves 242, 244, 246 are extend over approximately 270°. The first 242 is intersected by three holes 240 and restrictions 248 are placed along the groove 242 to control the flow, along the groove 242 between the holes 240.

The second groove 244 communicates by hole 240 with the circular gallery whereas the first and third grooves 242, 246 on the inner pitch circle communicate with the recesses in the kidney gallery 230.

At the intermediate pitch circle, a single groove 250 is provided that communicates through hole 240 with the recess 232.

At the radially outer pitch circle, three grooves 252, 254, 256 are also provided, the intermediate of which 254 communicates with the circular gallery 236 through hole 240 whilst the first and third grooves communicate with the kidney gallery 230 through respective holes 240.

The galleries 230, 236 are sealed by a cover 258 and a high flow rate, low vacuum source is applied through connector 260 to the kidney gallery 230. A relatively low flow rate, high vacuum is applied to the radial port 238. Therefore as the hub 168 rotates relative to the valve plate 210 in the direction indicated by the arrow in FIG. 7, the feeder galleries 218, 220, 222 are selectively connected to high and low vacuum sources to control the retention of the label on the label station 47 as it moves from the knife station 42 to the conveyor 50.

To provide optimum control of the label as it is placed on the label station and subsequently removed, each of the radial tracks is associated with a different portion of the label station 47. As can be seen in FIG. 5, each station has a lead land 262 and a tail land 264. Respective branches 212 are associated with each of those lands. Branches 212 are also provided in advance of the lead land 262 to control initial placement of the label. When the label is initially fed to the carrier at the knife station, the carrier is moving faster than the web stock 37 to keep the stock under tension. Accordingly the lead edge of the label is provided in advance of the lead land and the label caused to slip into the final position on the lead land as the tail is cut. A branch 212 is therefore provided in advance of the land to hold the lead edge of the label whilst allowing it to slip.

A further problem encountered during transfer to the label is the tendency for the lead and tail to try to enter the glue station 48 as it passes. This may be prevented with hot wire barriers but with heat sensitive label stock this is not practical. Finally, as the label is presented to the container, it must be released in a progressive manner to maintain it under tension as it is rolled on to the container.

To address these considerations with the arrangement shown in FIGS. 6 and 7, the groove 250 on the intermediate pitch circle is connected to the branches 212 in advance of the lead land 262. Thus only a single feeder gallery 220 will communicate with the radial gallery 216 supplying these branches 212.

The branches 212 are associated with the lead land 262 are connected to the feeder gallery 218 and hence the grooves the radically inner location and the tail land 264 is connected to feeder gallery 222 for connection to the grooves at the radically outer location.

As the label carrier rotates across the valve plate, it will be apparent that initially a low vacuum is applied in advance of the land 262 to hold the label the carrier nut allow slippage. When the head has moved to a position in which the label is located on the led land 262, low vacuum is applied to the branches of the lead land and the supply to the branches 212 in advance is removed. The low vacuum is applied to the tail land as the tail moves on to the carrier. As the lead land 262 passes the glue station, the branches 212 are connected to the high vacuum gallery to hold the lead on to the carrier. Similarly, the tail land is supplied with high vacuum as it passes the glue station.

As the label approaches the container, the branches 212 will be successively disconnected and the label released.

Accordingly, a full and progressive control of the label is provided with different levels of vacuum as the label moves from the knife station to the container.

The application of adhesive to the label is critical in maintaining the aesthetics of the finished container. A glue station 48 is shown in FIG. 11 which provides the requisite control of glue to the label. Glue station 48 includes a base 270 with a support frame 272 projecting from the base 270. The frame 272 includes a pair of side members 274 and a cross member 276 connecting the side members. The base 270 has an annular gutter 278 formed in it to drain excess glue and return it to a reservoir 280.

The base 270 also has a race 282 formed on an upper surface with a set of ball bearings 284 located in the race. The ball bearings support the lower edge 286 of a glue roller 288 which has a complementary race 290 engaging the bearings 284. Glue roller 288 is cylindrical with an end cap 292 at the upper end. A shaft 294 is secured to the end cap and is received in a bushing 296 on cross member 276. The bushing allows axial movement between the shaft 294 and cross member 276 whilst locating the shaft for rotation. Shaft 294 is connected to a drive gear 298 driven by the motor.

A doctor blade 300 is secured to one of the side members 274 and is adjusted to wipe the surface of the glue roller 288 as it rotates. Glue is supplied from the reservoir 280 by pump 302 to a nozzle 304 so it may flow over the roller 288 and be doctored by blade 300.

The roller 288 is heated by a heater block 306 located within the roller 288 and separated from the base by an insulator 308 the block 306 is heated by electrical elements 310 supplied by wires 312.

In operation, the roller is rotated and glue applied to the label as it passes the surface of the roller. The lands 262, 264 provide a pair of high points for engagement with the surface of the roller so that glue is applied only to the lead and tail edge, as is well known.

Lateral loading of the roller is accommodated by the bearing at the lower end of the roller 288 and thermal expansion of the frame is accommodated by the axial floating of the shaft in the cross member. A stable simple glue station is thus provided.

Alternative bearing arrangements could be used, such as a chamfered surface lubricated with the glue provided a lateral location is provided.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A labeling machine having a roll of labels, a knife station to sever the labels from said roll, and a label carrier to carry the labels from the knife station to a container, said knife station including a stationary knife assembly and a rotating knife assembly mounted in a housing, said housing being rotatable relative to the carrier to provide access to said knife assemblies.

2. A labeling machine according to claim 1 wherein said rotating knife assembly is driven from a drive shaft and said housing is rotatable about the axis of said drive shaft.

3. A labeling machine according to claim 2 wherein said rotating knife assembly is connected to said drive shaft by a pair of gears.

4. A labeling machine according to claim 1 wherein said knife assemblies are maintained in spatially fixed relationship by said housing during rotation of said housing relative to said corner.

5. A labeling machine according to claim 4 wherein said rotating knife assembly is mounted on a driver shaft in said housing and said driver shaft is connected through a transmission to a drive shaft, said housing being rotatable about the axis of said drive shaft.

6. A labeling machine according to claim 5 wherein said drive shaft and driver shaft are arrayed in spaced parallel relationship and said transmission is provided by a pair of gears mounted on respective ones of said shafts.

7. A labeling machine according to claim 6 wherein said housing is slidably mounted on said drive shaft to permit removal therefrom and disengagement of said gears.

8. A labeling machine according to claim 4 wherein said stationary knife assembly includes an anvil secured to a support in said housing and disposed adjacent a blade on said rotating knife assembly.

9. A labeling machine according to claim 8 wherein said anvil is adjustable relative to said support.

10. A labeling machine according to claim 9 wherein said anvil is mounted on a portion of said support and said portion is adjustable relative to said housing.

11. A labeling machine having a knife station to sever labels from said roll and a label carrier to carry labels from said knife station to a container, said knife station including a stationary knife assembly and a rotating knife assembly, said stationary knife assembly including a support having a pair of legs and an anvil mounted on one of said legs, said support including an adjusting element acting between said legs to vary the spacing therebetween and thereby the position of the anvil relative to said rotating knife assembly.

12. A labeling machine according to claim 11 wherein said anvil is adjustable relative to said support.

13. A labeling machine according to claim 12 wherein said knife station includes a housing, the other leg of said support and said rotating knife assembly being secured to said housing in spaced relationship whereby adjustment of the spacing between said legs adjust the position of said anvil relative to said rotating knife assembly.

14. A labeling machine according to claim 13 wherein spacing between said legs is adjustable by means of a threaded member.
